(19) United States
(12) Patent Application Publication
(10) Pub. No.: US 2026/0195186 A1
(43) Pub. Date: Jul. 9, 2026

(54) SUSTAINABLE DATA MANAGEMENT CONTROLLER

(71) Applicant: International Business Machines Corporation, Armonk, NY (US)

(72) Inventors: KEDAR M KARMARKAR, PUNE (IN); Abhishek Jain, Baraut (IN); Rachana Vishwanathula, Hyderabad (IN); SARIKA SINHA, Bangalore (IN)

(21) Appl. No.: 19/012,101

(22) Filed: Jan. 7, 2025

(51) Int. Cl. G06Q 30/018

(52) U.S. Cl. CPC G06F 9/505; G06Q 30/018

(57) ABSTRACT

Mechanisms are provided for processing requests regarding user application data in accordance with sustainability metrics and limits. The mechanisms include a sustainability data management (SDM) controller that receives a designation of a SDM policy to be applied to user application data and specifies a sustainability limit. The SDM controller receives, from agents deployed to a computing system, SDM data collected from sensors. Sustainability metric(s) for computing devices of the computing system are determined based on the SDM data. In response to receiving a request targeting user application data, computing device(s) are selected, based on the sustainability metric(s) and the sustainability limit of the SDM policy, with which to process the request. The request is then processed using the selected computing device(s) of the computing system.

### BACKGROUND

The present application relates generally to a data processing apparatus and method and more specifically to a computing tool and computing tool operations/functionality for providing a sustainable data management controller.

Sustainability is the ability to maintain and support a process over time. With regard to the operation of an organization, sustainability refers to not only the ability to maintain and support the operations of the organization, but also to protect natural resources and the environment so as not to deplete these resources or harm the environment. This ensures that resources are available and the environment is conducive to continued operation of the organization.

One measure of impact of an organization on the environment is the concept of carbon credits. A carbon credit is a permit that allows the owner of the permit to emit a certain amount of carbon dioxide or other greenhouse gases (GHGs). One carbon credit represents the reduction of one unit of greenhouse gas emissions or the removal of carbon dioxide from the atmosphere. Organizations can receive credits when they cut their emissions below a predetermined threshold. If an organization has more carbon credits than they need, they may sell the excess on a carbon exchange or marketplace. This is done on an organization or geopolitical level.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises receiving a designation of a sustainability data management (SDM) policy to be applied to data associated with a user application. The SDM policy specifies a sustainability limit for processing data associated with the user application. The method further comprises receiving, from one or more SDM data collection agents deployed to a computing system, SDM data collected by the SDM data collection agents from sensors associated with a plurality of computing devices of the computing system. In addition, the method comprises computing at least one sustainability metric for the plurality of computing devices of the computing system based on the SDM data. Moreover, the method comprises receiving a request, from the user application, targeting user application data, and selecting, based on the at least one sustainability metric and the sustainability limit of the SDM policy, at least one computing device, of the plurality of computing devices, with which to process the request. The method further comprises processing the request using the selected at least one computing device of the computing system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of heatmaps for different aisle of servers in a datacenter in accordance with one illustrative embodiment;

FIG. 2 is an example diagram of a distributed data processing system environment in which aspects of the illustrative embodiments may be implemented and at least some of the computer code involved in performing the inventive methods may be executed;

FIG. 3 is an example block diagram illustrating the primary operational components of a sustainability data management (SDM) controller in accordance with one illustrative embodiment;

FIG. 4 is an example diagram illustrating an example operation for placement of data in accordance with one illustrative embodiment;

FIG. 5 is an example diagram illustrating an example data access operation in accordance with one illustrative embodiment;

FIG. 6 is an example diagram illustrating an example sustainability metric marketplace operation in accordance with one illustrative embodiment; and

FIG. 7 presents a flowchart outlining example operations of elements of the present invention with regard to one or more illustrative embodiments.

### DETAILED DESCRIPTION

The illustrative embodiments provide an improved computing tool and improved computing tool operations/functionality for providing a sustainable data management controller. The sustainable data management controller operates to position data on computing devices to promote sustainability by positioning frequently accessed data on computing devices that have improved sustainability measures for the local environment than other computing devices available to store the data. For example, in a datacenter, server farm, or the like, the cooling state of individual computing devices, e.g., servers, storage systems, and the like, may be evaluated along with data access metrics to determine where to position data in the overall system so as to minimize the overall thermal and emissions impact of the system on the local environment and maximize sustainability with regard to the system.

The illustrative embodiments have been developed with the understanding that enterprises and organizations now have recently implemented sustainability goals that seek to achieve net zero emissions. Executive sustainability reports for such organizations and enterprises often now include the organization's carbon consumption, water consumption, waste consumption, and the like. With a large scale computing system, such as a datacenter, server farm, or the like, the cooling state of the individual computing devices, e.g., servers, is directly responsible for the water consumption of the computing system and the number of carbon units the servers of the computing system are releasing. Such cooling and water consumption is a scope-1 factor (direct emissions owned and controlled by the organization) for organization sustainability.

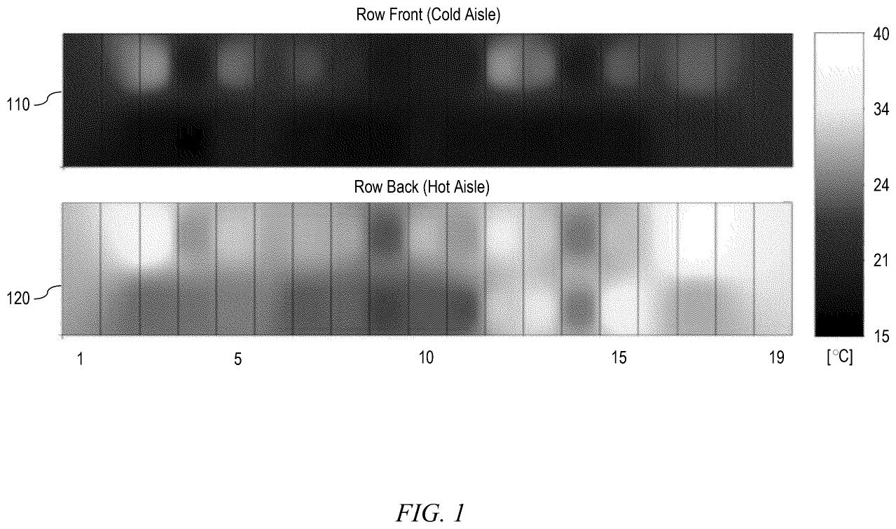

The cooling state of the individual computing devices, hereafter assumed to be servers for ease of explanation, but not intending to limit the present invention to only server computing devices, may be represented as a heatmap, where the heatmap may represent various emissions related metrics, such as the amount of time required for servers to cool down, power consumption, emissions levels, or the like. Thermal mapping may also be done for the servers in datacenters, server farms, and the like, where the thermal mapping shows a visual representation of how cool/hot the servers are. FIG. 1 is an example diagram of a heatmap for two rows of servers in a datacenter, where the first row 110 represents a cold aisle of the datacenter and the second row 120 represents a hot aisle of the datacenter. There are existing technologies for generating such heatmaps based on servers in racks and their respective temperatures. Similarly, such heatmaps can be created based on other metrics, such as humidity, pressure, power consumption, and the like, for large scale computing systems, such as datacenters, server farms, and the like.

It has been recognized that data present on hot servers leads to an increase in sustainability metrics versus established sustainability limits. That is, data on hot servers ultimately causes an increase in the amount of carbon equivalents released, water required to cool down the servers, waste generated (indirect metric based on wear and tear of servers), and the like. However, there is no existing technology to control the placement, access, and moving of data on computing devices, such as in the large scale computing systems, based on dynamically determined sustainability metrics and established sustainability limits. In addition, there is no existing technology that provides an ability to transfer and balance carbon credits among data storage devices within a computing system such that the totality of data storage in the computing system can meet a desired sustainability target, e.g., carbon emission target, taking into consideration data access patterns and individual computing device sustainability metrics.

The illustrative embodiments provide an improved computing tool and improved computing tool operations/functionality that provides a sustainable data management controller which assists application users to define sustainability metric limits on individual files/objects or groups of files/objects, such as at a bucket level, so that the data placement and access is performed in a way that keeps sustainability metrics of individual computing devices and/or a computing system as a whole, within the predefined sustainability metric limits. For purposes of the present description, it will be assumed that the sustainability metric is a carbon emissions metric as an example, but the illustrative embodiments are not limited to such and may be used with any suitable sustainability metric, such as water consumption, thermal pollution, etc. Thus, for purposes of the present description, reference will be made to carbon credits as the units of measure for defining sustainability limits and for gauging whether a computing device or computing system is within these limits. If other sustainability metrics are utilized instead, an appropriate unit of measure of measuring sustainability limits and ensuring compliance of computing devices/systems may be utilized.

In addition, it should be appreciated that the present description makes reference to computing devices and computing systems. A computing system, such as a datacenter, server farm, or the like, is comprises of a plurality of computing devices of the same or different types. For purposes of the present description, it will be assumed that the computing system is a datacenter and that the computing devices are server computing devices within the datacenter and which store data in a manner that the data may be accessed by one or more users via one or more data networks and user computing devices. This is only intended to be an example architecture and is not intended to place any limits on the possible implementations of the mechanisms of the illustrative embodiments. The illustrative embodiments may be implemented with regard to other types of computing devices and other types of computing systems without departing from the spirit and scope of the present invention.

As noted above, the illustrative embodiments provide a sustainability data management (SDM) controller. The SDM controller may be implemented on a computing device of a computing system, e.g., a server of a datacenter, and may comprise computer hardware configured by specialized computing software that causes the computing device to be specifically configured to perform the operations described hereafter with regard to the SDM controller.

The SDM controller operates to dynamically collect detailed data for each server's condition in the datacenter and generates one or more heatmap representations from the datacenter sensors. The one or more heatmap representations represent one or more sustainability metrics, e.g., co2eqs, water required to cool down the server, wear and tear of the hardware, and the like, on an individual server basis and/or group of servers basis, e.g., aisles of the datacenter. Over time the data collection and heatmap generation provides a basis for calculating the changes in sustainability metrics while placing/accessing data on the servers of the datacenter. The data collection and heatmap generation may be performed with regard to both hot and cold available servers and aisles of the datacenter, for example. Based on the heatmap representations, and the changes over time, determinations are made as to where to store incoming data for accessing, where to move data for accessing, and the like, so as to place data that is more frequently accessed on colder servers and data that is less frequently accessed on hotter servers. The term “cold” as used herein refers to servers that have relatively lower emissions or sustainability metrics, and the term “hot” as used herein refers to servers that have relatively higher emissions or sustainability metrics.

The SDM controller operates to perform a balancing of sustainability criteria amongst the available servers so as to ensure that the sustainability limits of individual servers, groups of servers, and/or the datacenter as a whole are maintained within the sustainability limits. For example, in an embodiment where the sustainability limits are defined in terms of carbon credits, the carbon credit usage of individual servers, groups of servers, and/or the datacenter as a whole may be determined and compared to corresponding carbon credit limits. The determination of carbon credit usage may be tied to specific data, e.g., files/objects, based on their frequency of access. That is, individual files/objects will have their own corresponding carbon credit usage metrics indicating the amount of carbon credits required to store that data on a given server due to the frequency of accessing that data, where more frequently accessed data will have relatively higher carbon credit usage and less frequently accessed data will have relatively lower carbon credit usage. Thus, the sum of the carbon credit usage of the individual files/objects maintained by a server is indicative of the carbon credit usage of the server as a whole.

The comparison of carbon credit usage to carbon credit limits may be used to drive storage of data so as to reduce carbon credit usage to ensure maintaining carbon credit usage within the defined limits. For example, if one group of servers is running “hot” with regard to carbon credit usage, i.e., has been using a relatively greater number of carbon credits, then some of the data stored on these servers may be moved, and/or new data storage may be redirected, to other “colder” servers to thereby reduce the carbon credit usage of the relatively hotter servers and increase the carbon credit usage of the colder servers, and thereby balance the sustainability impact of the servers. The particular data that is moved or redirected may be based on a determination of the individual files/object carbon credit usage metrics. Thus, more frequently accessed files/objects, having relatively higher carbon credit usage metrics, will be moved or redirected and relatively lower carbon credit usage files/objects may be maintained on the “hotter” servers.

In another embodiment, the SDM controller may implement a computing system specific carbon credit marketplace through which the SDM controller facilitates loaning of carbon credits among data (files and objects) placed on the server so that a dataset can maintain their carbon emission target even if few of the files/objects are getting accessed heavily and going beyond their individual credit limit. This loaning may be performed between files and objects on the same server, as well as files and objects across different servers of the datacenter. Thus, a sustainability market is made possible on an individual computing device level and on a computing system level.

Thus, with the improved computing tool and improved computing tool operations/functionality of the illustrative embodiments, a SDM controller is provided that enhances the capabilities of existing data management controllers by providing an improved capability to track each file/object or group of files/objects, such as on a bucket basis, to ensure sustainability limits are not violated and sustainability goals are achieved. The SDM controller collects dynamic heatmap data for individual computing devices, groups of computing devices, and/or the computing system as a whole, and utilizes sustainability metrics for these computing devices/computing system to measure adherence to these limits and goals. The sustainability metrics may be collected and/or calculated for individual files/objects being placed in the storage of the individual computing devices and/or already being maintained in the storage of the individual computing devices. One or more data placement policies may be implemented in the SDM controller so as to place and move data, e.g., files/objects, within the computing system so as to meet the requirements of sustainability limits and goals. Moreover, one or more policies may be provided to control application accesses to copies of data (files/objects) in a manner that minimizes sustainability metric usage.

In some illustrative embodiments, the SDM controller facilitates a sustainability metric marketplace for loaning sustainability metrics between files/objects, groups of files/objects, computing devices, and groups of computing devices. This allows for balancing sustainability metric usage across files/objects in cases where some files/objects are more frequently accessed than others. That is, the sustainability metric marketplace permits the transfer of sustainability credits such that groups of files/objects can assist one another to not go beyond the overall sustainability limits defined by application users and also implemented by organizations.

The present description provides examples of embodiments of the present disclosure, and variations and substitutions may be made in other embodiments. Several examples will now be provided to further clarify various aspects of the present disclosure.

Example 1: A method comprising: receiving a designation of a sustainability data management (SDM) policy to be applied to data associated with a user application, wherein the SDM policy specifies a sustainability limit for processing data associated with the user application; receiving, from one or more SDM data collection agents deployed to a computing system, SDM data collected by the SDM data collection agents from sensors associated with a plurality of computing devices of the computing system; computing at least one sustainability metric for the plurality of computing devices of the computing system based on the SDM data; receiving a request, from the user application, targeting user application data; selecting, based on the at least one sustainability metric and the sustainability limit of the SDM policy, at least one computing device, of the plurality of computing devices, with which to process the request; and processing the request using the selected at least one computing device of the computing system.

The above limitations advantageously enable the selection of a computing device to process a request based on an evaluation of sustainability metrics and SDM policy. This allows for controlling and potentially minimizing the environmental impact of data access request processing.

Example 2: The limitations of any of Examples 1 and 3-10, where the request is a request to store the user application data to the computing system. The above limitation advantageously enables controlling the environmental impact of store operations for storing data to computing systems. In this way, data may be stored to computing systems where data accesses may be determined to cause less of an environmental impact of the computing system on its environment.

Example 3: The limitations of any of Examples 1-2 and 4-10, where the request is a request to access the user application data from the computing system. The above limitation advantageously enables controlling the environmental impact of access operations for accessing already stored data from computing devices of the computing system. For example, the above limitations may permit accessing instances of data from relatively cooler computing devices which will cause less of an environmental impact than accessing data from relatively hotter computing devices.

Example 4: The limitations of any of Examples 1-3 and 5-10, where the sustainability limit is a maximum carbon credit usage, and where the sustainability metric is an amount of carbon credit usage that would occur if using a specified computing device, or group of computing devices, to process a request. The above limitations advantageously enable the selection of computing devices to process requests by taking into account the carbon credit usage of the computing devices and a maximum carbon credit usage limit so as to ensure that data accesses are within the acceptable environment impact limits of an organization operating the computing system.

Example 5: The limitations of any of Examples 1-4 and 6-10, where selecting at least one computing device further comprises performing a sustainability unit transfers between computing devices of the plurality of computing devices to provide the selected at least one computing device enough sustainability units to process the request. The above limitations advantageously enable the balancing of sustainability units between computing devices which may have variations in their usage when processing requests, thereby making it possible to maintain the overall operation of the computing system within limits specified by the SDM policy.

Example 6: The limitations of any of Examples 1-5 and 7-10, where computing at least one sustainability metric for the plurality of computing devices of the computing system based on the SDM data comprise computing, for each data object or file of each computing system, a corresponding sustainability metric, and where a sustainability metric for a computing device comprises a sum of the sustainability metrics for the data objects and files stored on the computing device. The above limitations advantageously enable the controlling of sustainability unit usage and selection of computing devices on a data object or file level basis.

Example 7: The limitations of any of Examples 1-6 and 8-10, where the method further comprises moving data objects and files between computing devices in the plurality of computing devices based on the sustainability metrics of the data objects or files of the computing devices and the SDM policy. The above limitations advantageously enable movement of data between relatively hotter and relatively cooler computing devices so as to balance sustainability unit usage across the computing system.

Example 8: The limitations of any of Examples 1-7 and 9-10, where the SDM policy minimizes usage of the at least one sustainability metric across the plurality of computing devices. The above limitations advantageously enable the minimizing of the environmental impact of a computing system by minimizing the usage of sustainability metrics across the computing devices of the computing system.

Example 9: The limitations of any of Examples 1-8 and 10, where computing the at least one sustainability metric for the plurality of computing devices of the computing system based on the SDM data further comprises generating one or more heatmaps of the at least one sustainability metric, and wherein selecting the at least one computing device is performed based on the one or more heatmaps. The above limitations advantageously enable the selection of a computing device to process a request using heatmap analysis that represents the plurality of computing devices relative to each other.

Example 10: The limitations of any of Examples 1-9, where the one or more sustainability metrics comprise at least one of a carbon dioxide equivalent metric, an amount of water required to cool down a corresponding computing device, or a measure of wear and tear on hardware of the corresponding computing device. The above limitations advantageously enable the selection of a computing device to process a request based on any one or more of a plurality of different types of sustainability metrics.

Example 11: A computer program product comprising one or more computer readable storage media, and program instructions collectively stored on the one or more computer readable storage media, the program instructions comprising instructions configured to cause one or more processors to perform a method according to any one of Examples 1-10. The above limitations advantageously enable a computer program product having program instructions configured to cause one or more processors to perform and realize the advantages described with respect to Examples 1-10.

Example 12: A system comprising one or more processors and one or more computer-readable storage media collectively storing program instructions which, when executed by the one or more processors, are configured to cause the one or more processors to perform a method according to any one of Examples 1-10. The above limitations advantageously enable a system comprising one or more processors to perform and realize the advantages described with respect to Examples 1-10.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a proactive sustainability data management (SDM) controller that dynamically and actively stores data and moves data amongst computing devices of a computing system to as to maintain and achieve sustainability goals for the computing system. The improved computing tool implements mechanism and functionality, such as the SDM controller, which cannot be practically performed by human beings either outside of, or with the assistance of, a technical environment, such as a mental process or the like. The improved computing tool provides a practical application of the methodology at least in that the improved computing tool is able to optimize data placement and maintenance within large scale computing systems in accordance with sustainability limits and goals so as to promote minimizing the impact of computing systems on the local environment.

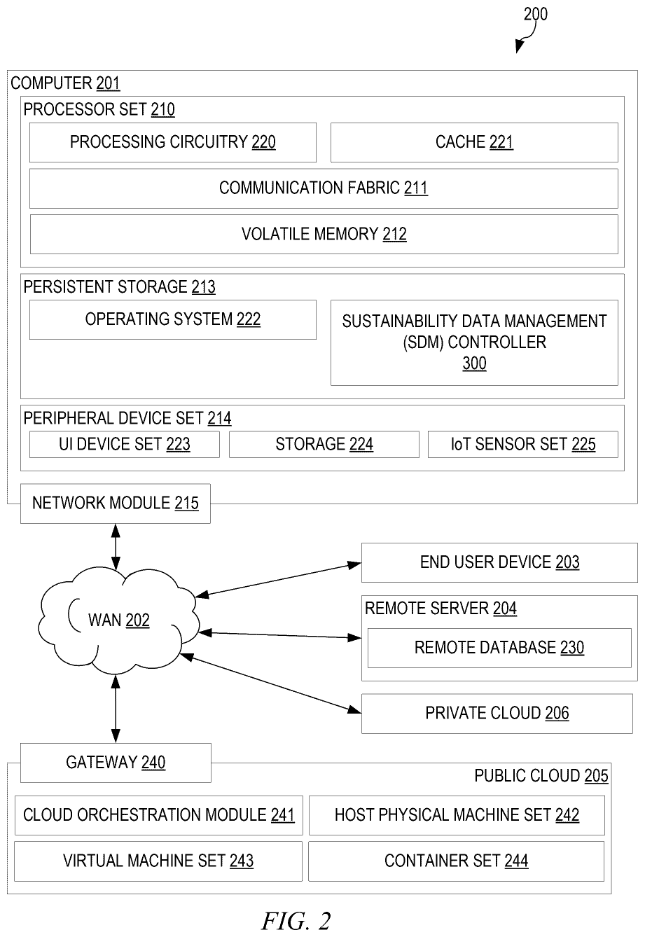

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as sustainability data management (SDM) controller 300. In addition to SDM controller 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and SDM controller 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in SDM controller 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in SDM controller 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a SDM controller 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates active and dynamic sustainability data collection and analysis as well as data placement and movement amongst computing devices of a large scale computing system so as to achieve sustainability goals and maintain sustainability metric usage within defined sustainability limits.

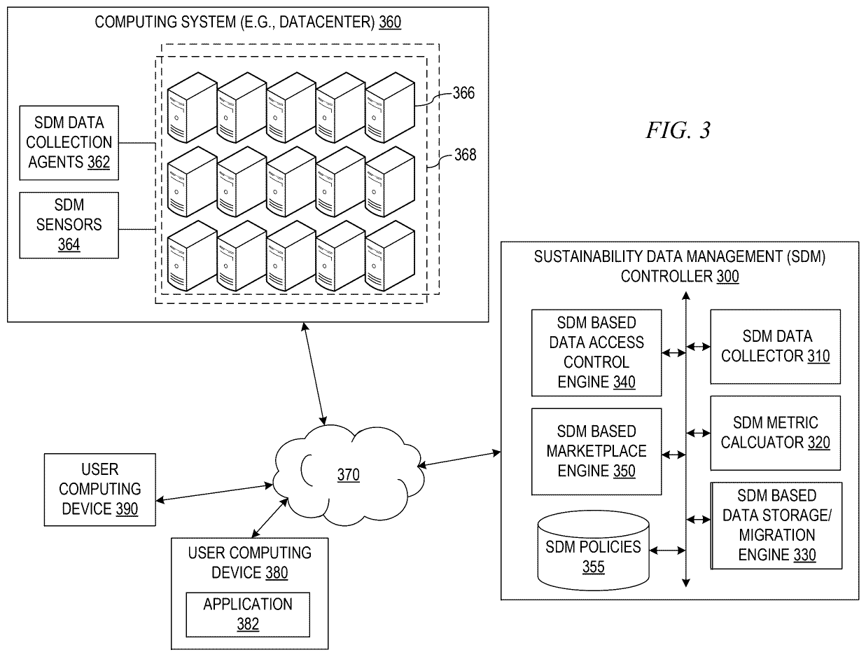

FIG. 3 is an example block diagram illustrating the primary operational components of a sustainability data management (SDM) controller in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that data placement and storage is performed, and providing a specific solution that implements a SDM controller that determines dynamically how to locate and maintain data within a computing system with regard to sustainability limits and goals, which cannot be practically performed by human beings as a mental process and is not directed to organizing any human activity.

As shown in FIG. 3, the SDM controller 300 comprises a SDM data collector 310, a SDM metric calculator 320, a SDM based data storage/migration engine 330, a SDM based data access control engine 340, a SDM based marketplace engine 350, and an SDM policies storage system 355. The SDM controller 300 operates in conjunction with a computing system 360, such as a datacenter, server farm, or other large scale computing system comprising a plurality of computing devices 366. These computing devices 366 may be servers, storage devices, or any other suitable type of computing device 366 for facilitating the storage and accessing of data on behalf of one or more users via one or more user computing devices 380, 390 via one or more data networks 370. The SDM controller 300 operates with the computing system 360 to evaluate the SDM metrics of the computing devices 366 and perform operations to store, move, and access data, e.g., files/objects, in a manner that ensures that sustainability limits and goals are met.

As shown in FIG. 3, the computing system 360, e.g., datacenter, comprises a plurality of computing devices 366 which may be organized into one or more computing device groups 368. For example, the computing devices 366 may be server computing devices 366 organized into racks or other physical/logical groupings 368. The computing system 360 may further include SDM data collection agents 362 and SDM sensors 364. The SDM data collection agents 362 collect the necessary data for characterizing the sustainability metrics for the computing devices 366 and groupings 368, as well as the computing system 360 as a whole. This data may be collected from SDM sensors 364 deployed in the environment of the computing system 360 and in the computing system 360 itself, e.g., temperature sensors, water usage sensors for cooling systems, data access sensors or logging logic, and the like. The SDM data collection agents 362 may interface with the SDM sensors 364 and other controllers and hardware/software components of the computing devices 366 to collect this data and report it back to the SDM controller 300.

The computing system 360 stores data, e.g., files, objects, and the like, for a plurality of different users of a plurality of different user computing devices 380, 390. The user computing devices 380, 390 may execute various applications 382 that generate, store, modify, delete, and access the data on computing system 360. Moreover, via the applications 382 and/or other software components of the user computing devices 380, 390, the user computing devices 380, 390 may specify particular sustainability limits and goals associated with the data of those applications 382. In addition, operators and authorized administrators of the computing system 360 may set appropriate sustainability limits and goals for the computing system 360 and/or individual computing devices 366 or groupings of computing devices 368. These sustainability limits and goals may be stored in the SDM controller 300, such as in user and/or computing system registries or other data structures, such as in the SDM policies 355 or the like.

The SDM controller 300 operates to manage the data storage of the computing devices 366 of the computing system 360, e.g., the servers 366 of the datacenter 360. While the SDM controller 300 is shown as a separate entity from the computing system 360 in FIG. 3, it should be appreciated that in some illustrative embodiments, the SDM controller 300 may be integrated into the computing system 360. That is, the SDM controller 300 may be implemented on a computing device 366 of the computing system 360 and may operate internal to the computing system 360 to manage the data of the various computing devices 366, e.g., the servers of the datacenter.

The SDM controller 300 communicates with the SDM data collection agents 362 of the computing system 360 to obtain SDM data. The SDM data may be captured by SDM sensors 364, which may be various types of sensors including, but not limited to, power meters, emissions sensors, temperature sensors, and the like. The SDM data generated by the SDM sensors 364 based on their monitoring of activities and conditions of the computing system 360, and collected by the SDM data collection agents 362, which may be software applications executing on one or more of the computing devices 366, may be used by the SDM controller 300 to generate SDM metrics and heatmap representations of the dynamic conditions of the computing system 360 as well as individual computing devices 366 and/or computing device groupings 368. One example of a tool that may be utilized to collect such SDM data and generate such SDM metrics is the IBM® Cloud Carbon Calculator, available from International Business Machines (IBM®) Corporation of Armonk, New York. The SDM metrics and heatmap representations may be further reduced down to individual data, e.g., files/objects, level SDM metrics such that one can determine from the dynamic access patterns of particular files/objects, the SDM metrics associated with those files/objects.

The SDM data collector 310 of the SDM controller 300 operates to collect the SDM data from the SDM data collection agents 362 via the one or more data networks 370, or in embodiments where the SDM controller 300 is integrated with the computing system 360, directly from the SDM data collection agents 362 or through local data networks (not shown). The SDM data is provided to the SDM metric calculator 320 which generates SDM metrics, such as carbon credit usage metrics, for example, from the collected SDM data. This may further include generating a heatmap representation of individual computing devices 366, groupings of computing devices 366, and/or the computing system 360 as a whole. The SDM metric calculator 320 further performs computations and calculations to determine how the SDM metrics compare to sustainability limits and goals for an organization or user as specified in corresponding SDM policies 355. Thus, the SDM metric calculator 320 is able to identify instances of violations of SDM policies 355 by comparing SDM metrics with SDM policy limits or goals.

The SDM based data storage/migration engine 330, based on the SDM metric calculations and comparisons with SDM policy limits or goals, comprises logic to directed data storage to particular computing devices 366 or groups of computing devices 360, as well as migrate or move data from one computing device 366 or grouping of computing devices 368 to another to ensure that SDM policy limits or goals are achieved and/or to optimize the overall sustainability of the computing system 360. The determination of which computing devices 366 to use to store particular files/objects may be based on not only the SDM metrics of the individual computing devices 366, groupings 368, and the like, but also based on the SDM metrics associated with the file/object, e.g., as may be estimated from the frequency of access of the file/object. Thus, frequently accessed files/objects, which will have relatively higher SDM metric usage, may be stored on computing devices 366 which have relatively lower SDM metric usage, so as to balance the SDM metrics and ensure that sustainability limits and goals are achieved.

Thus, the SDM based data storage/migration engine 330 may instruct the computing system 360 as to the positioning of the files/objects within the computing system 360. This may include directing storage to computing devices 366 based on the heatmaps generated and the SDM metrics associated with the data. Moreover, historical data as to access logs and activity with regard to specific data, e.g., files/objects, may be maintained or accessed by the SDM controller 300 to determine which files/objects are more frequently/less frequently accessed and thus, may represent higher sustainability metric usage, e.g., carbon credit usage.

Similar to the SDM based data storage/migration engine 330, the SDM based data access control engine 340 may perform operations to direct data access requests to copies of data in accordance with the SDM policies 355. That is, whereas the SDM based data storage/migration engine 330 is concerned with where the data is stored in the computing system, the SDM based data access control engine 340 is concerned with which copy of the data is accessed by an application 382. In this way, the SDM based data access control engine 340 may throttle access request processing for various copies of the same data so as to ensure that the sustainability metrics are below the policy specified limits and/or meets with sustainability goals. That is, there may be multiple copies of the same data stored in different locations of the computing system 360, with some being on relatively “hotter” computing devices 366 and others on relatively “cooler” computing devices 366. In order to minimize sustainability metric usage, access requests may be directed to copies of data on relatively “cooler” computing devices 366 dynamically. However, doing so may eventually elevate that copy of data to be accessed more frequently and the corresponding location be associated with a relatively “hotter” computing device. Thus, this determination of which copy of data to access will need to be performed dynamically with updated dynamically obtained SDM data from the SDM sensors 364 and SDM data collection agents 362.

In some cases, it may not be advantageous to store data in relatively cooler computing devices 366 or to move data to relatively cooler computing devices 366. In such situations, it may be a more advantageous solution to implement a sustainability metric marketplace between computing devices 366 and/or groups of computing devices 368, or between different files/objects stored on these devices 366, so as to ensure adherence to the SDM policies 355. The SDM based marketplace engine 350 trades sustainability metric usages between files/objects, computing devices, groups of computing devices, and the like, so as to ensure such adherence. This allows for providing a relatively larger amount of sustainability metric usage to files/objects that are more frequently accessed, and a relatively smaller amount of such sustainability metrics to files/objects that are less frequently accessed. Similar marketplace activities may also be applied to the computing devices 366 and/or groupings of computing devices 368 on a higher level of granularity covering multiple different files/objects. Thus, for example, the SDM based marketplace engine 350 may trade carbon credits between files/objects, groups of files/objects, computing devices 366, groups of computing devices 368, or the like, in whichever necessary way to ensure that the SDM policies 355 are satisfied.

For example, in some illustrative embodiments, sustainability for a cloud based storage solution, where the computing system 360 comprises a plurality of cloud provided data storage devices, e.g., servers 366 which may be distributed across multiple geographical locations, may be calculated as the sum of the carbon intensity of the electrical power grid and the power consumed by the cloud based storage solution, where carbon intensity is defined by the energy mix that the electrical grid uses. The carbon intensity may be determined on a regional basis for different regions which the computing system 360 spans. The power consumed by the particular storage instance is defined by two factors, i.e., information technology (IT) power consumption and non-IT power consumption. That is, P(IT) is the power used by the servers 366 to run the storage instances, and P(non-IT) is the power used to keep the computing system 360, e.g., datacenter, up and running, which includes the power used by cooling systems and chillers, for example. The higher the power consumption, the higher the carbon emission scores. Thus, the overall sustainability of a computing system 360 is the sum of carbon intensity (CI) of the electrical power grid for the regions spanned by the computing system 360, P(IT) of the storage instances, and P(non-IT) for the computing system 360. The illustrative embodiments may use such calculations to compute and evaluate the sustainability of individual storage instances, e.g., files/objects, as well as the computing devices 366 and groupings of computing devices 368 in the computing system 360.

The SDM based data storage migration engine 330 and SDM based data access control engine 340 may utilize such calculations and evaluations to investigate different potential scenarios for storage, migration, and accessing of data of the computing system 360. For example, various scenarios may be evaluated, such as what is the sustainability if the data is placed only on relatively cool computing devices 366, what is the sustainability if the data is placed in only medium temperature computing devices 366, what is the sustainability if the data is placed in only relatively hot computing devices 366, and what is the sustainability if the data is placed in some other combinations of hot, medium, and/or cold computing devices 366. The resulting sustainability measures calculated for these various scenarios may be compared against the sustainability limits and goals set forth in the SDM policies 355 to determine which, if any, satisfy the requirements of these policies 355. From those that meet the requirements of the policies 355, a best performing option may be selected, e.g., the one that results in minimum sustainability metric usage. The corresponding engine 330, 340 may then issue command signals to the controllers of the computing system 360 so as to direct storage of the data, e.g., files/objects, in accordance with the selected storage/data access option.

Thus, for example, an application user of an application 382 may define a carbon emission goal for their files/objects/data placed in the datacenter 360 and thereby establish an SDM policy 355. The SDM controller 300, via the SDM data collector 310 collects dynamic SDM data from the SDM data collection agents 362 of the datacenter 360 for generation of dynamic heatmap representations of the datacenter 360 based on geolocation in the datacenter 360. The SDM metric calculator 320 may calculate SDM metrics, e.g., carbon emissions, carbon credit usage, or the like, for various scenarios. For example, the SDM metric calculator 320 may calculate how much carbon emission will occur if all the copies of the files/objects are placed on relatively lower emitting hardware versus all hot (higher emitting) hardware or a mixture of hot and cold hardware. The SDM controller 300 categorizes the hardware/racks, i.e., computing devices 366 and/or groupings of computing devices 368, and marks them with labels corresponding to their emission properties, e.g., high-low emitting co2eq, with these labels being able to be dynamically updated based on the dynamic collection of SDM data, e.g., the workloads of the various computing devices 366, groups of computing devices 368, and the like.

The SDM based data storage/migration engine 330 may operate in conjunction with the SDM metric calculator 320 to evaluate these various scenarios and determine if the SDM policy 355 can be satisfied for the files/objects that are to be stored, and/or which are already stored, in the datacenter 360 for the particular user (which may be an organization or an individual user). If the defined carbon limit of the SDM policy 355 for a file/object cannot be served by the datacenter 360, the application 382 user will be notified of the inability to meet the requirement, otherwise the data will be stored and/or migrated in accordance with the best performing option evaluated. For example, if a user asks for 2 co2eq, but the SDM policies 355 set forth a minimum of 6 co2eq per hour, the storage request may be rejected as unable to be satisfied in accordance with the existing SDM policies 355.

The cooling state of the individual computing devices 366, e.g., servers may be represented as a heatmap, where the heatmap may represent various emissions related metrics, e.g., co2 emissions, amount of time required for servers to cool down, water consumption, or the like. Thermal mapping may also be done for the servers 366 of the datacenter 360 where the thermal mapping shows a visual representation of how cool/hot the servers 366 are relative to a predetermined standard or scale. Based on the heatmap representations and thermal mapping, and the changes in these over time, the SDM based data storage/migration engine 330 makes determinations as to where to store incoming data for accessing, where to move existing data for accessing, and the like, so as to place data that is more frequently accessed on colder servers and data that is less frequently accessed on hotter servers. The term “cold” as used herein refers to servers that have relatively lower emissions or sustainability metrics, and the term “hot” as used herein refers to servers that have relatively higher emissions or sustainability metrics.

The SDM based data storage/migration engine 330 operates to perform a balancing of sustainability criteria amongst the available servers 366 so as to ensure that the sustainability limits of individual servers, groups of servers, and/or the datacenter as a whole, as specified in the SDM policies 355 are maintained within the sustainability limits. For example, in an embodiment where the sustainability limits are defined in terms of carbon credits, the carbon credit usage of individual servers 366, groups of servers 368, and/or the datacenter 360 as a whole may be determined and compared to corresponding carbon credit limits as set forth in applicable SDM policies 355. The determination of carbon credit usage may be tied to specific data, e.g., files/objects, based on their frequency of access and other SDM related data. Any data that may be used to characterize the sustainability impact of the storage and accessing of the files/objects may be utilized without departing from the spirit and scope of the present invention, including electrical power grid carbon intensity data, IT power consumption data, non-IT power consumption data, and the like.

That is, individual files/objects will have their own corresponding carbon credit usage metrics indicating the amount of carbon credits required to store that data on a given server 366 or group of servers 368 due to the frequency of accessing that data, where more frequently accessed data will have relatively higher carbon credit usage and less frequently accessed data will have relatively lower carbon credit usage. Thus, the sum of the carbon credit usage of the individual files/objects maintained by a server is indicative of the carbon credit usage of the server 366, or group of servers 368, as a whole.

The comparison of carbon credit usage to carbon credit limits may be used by the SDM based data storage/migration engine 330 to drive storage of data so as to reduce carbon credit usage to ensure maintaining carbon credit usage within the defined limits. For example, if one group of servers 368 is running “hot” with regard to carbon credit usage, i.e., has been using a relatively greater number of carbon credits, then some of the data stored on these servers 366 may be moved, and/or new data storage may be redirected, to other “colder” servers to thereby reduce the carbon credit usage of the relatively hotter servers and increase the carbon credit usage of the colder servers, and thereby balance the sustainability impact of the servers. The particular data that is moved or redirected may be based on a determination of the individual files/object carbon credit usage metrics. Thus, more frequently accessed files/objects, having relatively higher carbon credit usage metrics, will be moved or redirected and relatively lower carbon credit usage files/objects may be maintained on the “hotter” servers.

Similarly, the SDM based data access control engine 340 may perform operations to direct access requests to appropriate copies of data so as to ensure that the sustainability limits and goals of applicable SDM policies 355 are satisfied. That is, when storing data to the datacenter 360, multiple copies of that data may be stored for redundancy purposes. When routing data access requests, each of the locations of the copies may be evaluated to determine which copies are located in positions that, should they be accessed, will or will not satisfy the sustainability limits and goals set forth in the applicable policies 355. If copies exist on hot and cold servers 366, for example, then the access request may be redirected to the copy stored on the cold server rather than the hot server so as to minimize overall sustainability metric usage. Hence, dynamic redirect of access requests to copies of data based on sustainability metrics and sustainability limits/goals is made possible.

In some illustrative embodiments, the SDM based marketplace engine 350 of the SDM controller 300 may implement a computing system specific carbon credit marketplace through which the SDM controller 300 facilitates loaning of carbon credits among data (files and objects) placed on the servers 366 so that a dataset can maintain its carbon emissions within predefined limits or achieve desired goals, as specified in the applicable SDM policies 355. This may be done even if few of the files/objects are getting accessed heavily and going beyond their individual credit limit. This loaning may be performed between files and objects on the same server 366, as well as files and objects across different servers 366 and/or server groups 368 of the datacenter 360. Thus, a sustainability market is made possible on an individual computing device level and on a computing system level by way of the SDM based marketplace engine 350.

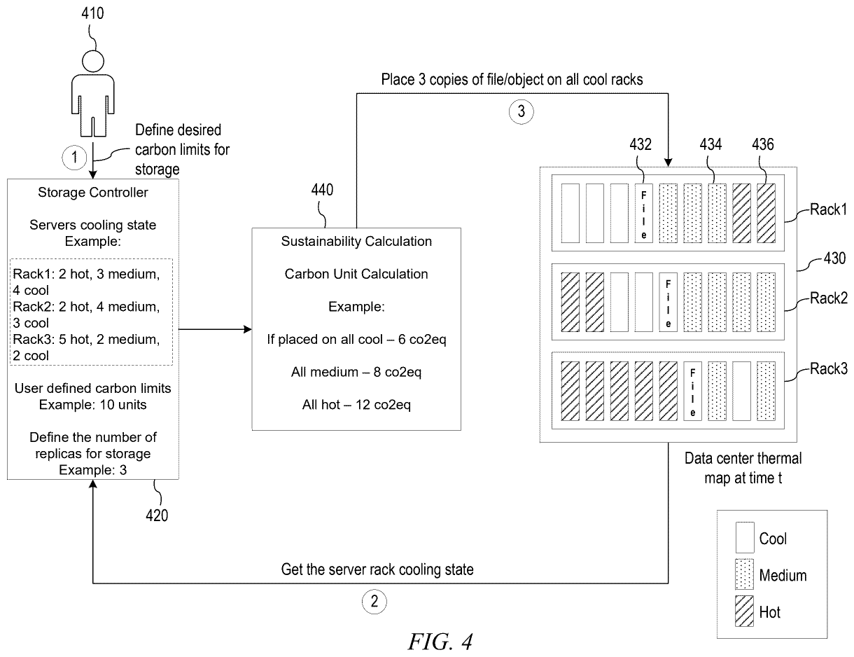

FIG. 4 is an example diagram illustrating an example operation for placement of data in accordance with one illustrative embodiment. It should be appreciated that the example shown in FIG. 4 has been simplified for ease of explanation and understanding. In actual implementations, the policies established, sustainability calculations, and decisions for storage of data may be more complex than this simplified example, but still is within the spirit and scope of the present description.

In the example scenario shown in FIG. 4, a user 410 defines, via the user application, a carbon limit for storage of data for their corresponding application and submits this carbon limit to the SDM controller 420 as an SDM policy to be enforced by the SDM controller 420. The SDM controller 420 collects server cooling state information from the various SDM data collection agents and the sensors of the datacenter 430. From the cooling state information collected, the SDM controller 420 classifies the various servers as to their carbon unit usage states, e.g., “hot”, “medium”, or “cold” based on established thresholds or boundaries for defining these classifications. In the depicted example, determines that Rack1 has 2 hot servers 436, 3 medium servers 434, and 4 cool servers 432. Similarly, the SDM controller 420 determines that Rack 2 has 2 hot, 4 medium, and 3 cool servers and Rack 3 has 5 hot, 2 medium, and 2 cool servers. Based on the user's definition for carbon limits for their application storage, the SDM controller 420 has a policy that specifies the user's carbon limit to be 10 units and that the number of storage replicas for the application data is 3.

Based on the current cooling state of the racks and servers, a sustainability calculation 440 may be performed by the SDM controller 420 to determine the carbon unit usage for various possible scenarios of data placement. For example, if scenarios may be evaluated based on whether the data for the application is placed only on cool servers, only on medium servers, or only on hot servers. The corresponding carbon unit usage may be calculated, for example, to be 6 co2eq, 8 co2eq, and 12co2eq, respectively. Again, one example tool that may be utilized to calculate such carbon unit usage may be the IBM® Cloud Carbon Calculator, for example.

From these calculations, and the previously defined carbon limits in the applicable SDM policies, it can be seen that placing the data on all the cool servers 432 (6 co2eq) or all the medium servers 434 (8 co2eq) would result in a sustainability that is below the carbon limit of 10 units. Thus, the SDM controller 420 may select either one of these options and according to its logic instructing it to select the option with the lowest value, selects the option to place the data on all the coolest servers 432. It should be appreciated that there may be other factors evaluated to determine whether to place the data on all cool servers, all medium servers, or other options, such server availability, reservations of server capacity by other entities, or the like.

It should be noted that the option to select may be further affected by other operational conditions of the servers which may dictate which of the options is available and thus, selecting the coolest servers may not always be the appropriate option to select. Based on the selected option, the files/objects, and their copies (3copies in this example) are stored on the corresponding servers, e.g., those marked “File” in FIG. 4.

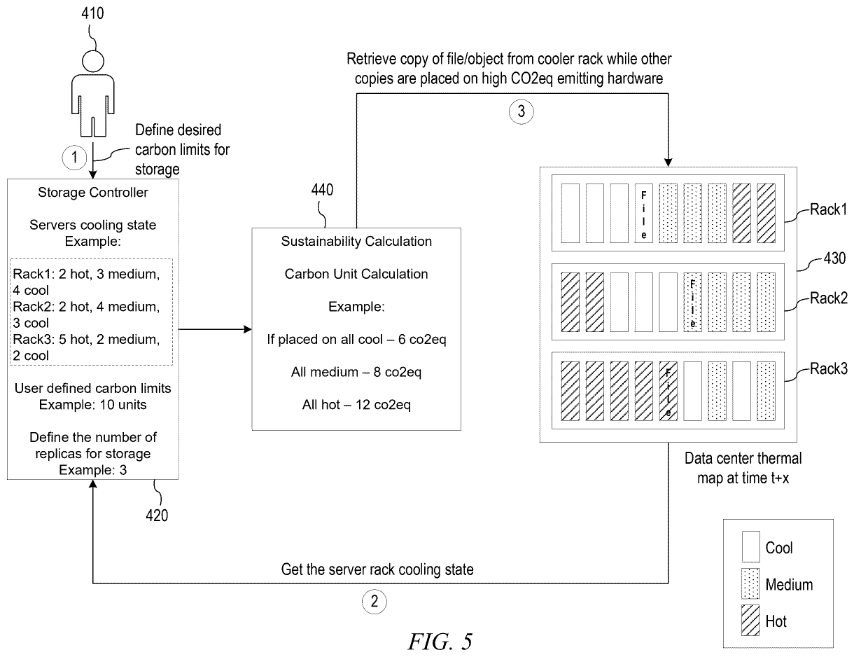

FIG. 5 is an example diagram illustrating an example data access operation in accordance with one illustrative embodiment. FIG. 5 shows the same datacenter at a subsequent time t+x in which the data previously stored, from FIG. 4, is not the subject of an access request. In this case, the files were stored on cool servers in the operation of FIG. 4, however at time t+x, the state of these servers has changed and only one copy of the files currently is present on a cool server (see Rack1), while the others are present on a medium and hot server (see Rack2 and Rack3). In this example, it is determined, based on the SDM policies, to access the data on the cool server of Rack1 as this will minimize the impact on sustainability as it will not create excessive carbon credit usage. Thus, the system accesses the copy of the data/file that is relatively cooler than other copies of the data/file. It should be noted that the SDM policies may not always dictate that the data be accessed from the coolest servers, and instead other factors may be considered when determining from where to access the data. Thus, the copy of the data/file that is relatively cooler than other copies.

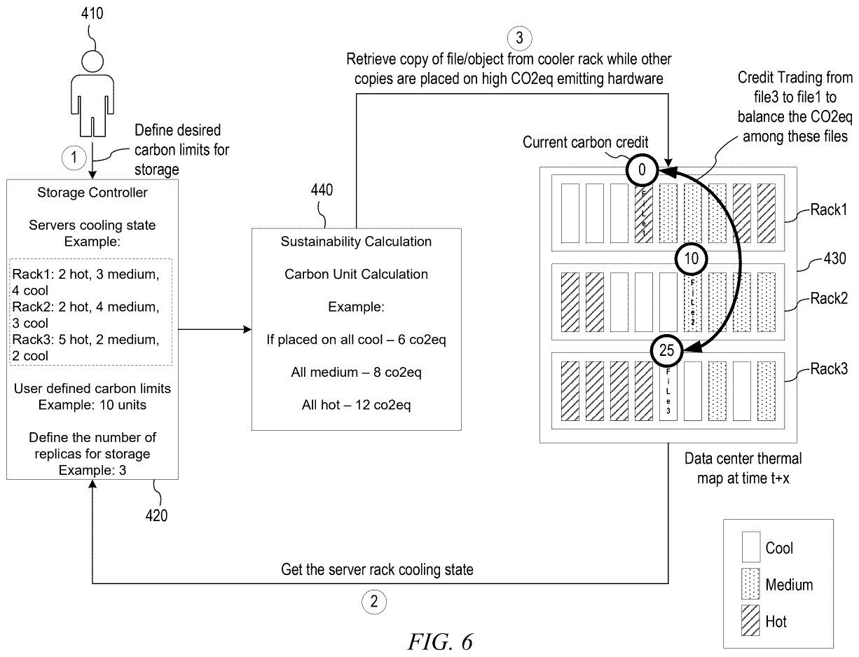

FIG. 6 is an example diagram illustrating an example sustainability metric marketplace operation in accordance with one illustrative embodiment. FIG. 6 shows an alternative situation to that of FIG. 5 in which carbon credits may be transferred, via the marketplace mechanisms of the illustrative embodiments, between file instances on different servers of different racks in order to maintain the sustainability metrics of the datacenter 430 within the sustainability limits and goals of the organization as specified in the SDM policies. In this case, the copies of different files may be accessed from different locations on different racks by transferring carbon credits between these files. For example, the file1 location on Rack1 may be accessed by transferring carbon credits from a relatively lower frequency of access file storage location in Rack3 to the relatively more frequently accessed file storage location in Rack1.

In this example, the copy of the file 3 in Rack3 is not accessed very often and thus, still has a large number of carbon credits associated with this instance of file 3. However, the relatively more frequently accessed copy of file 1 in Rack1 has no remaining carbon credits. Thus, without transferring carbon credits, in accordance with the SDM policies, the copy of file 1 in Rack1 would not be able to be accessed and maintain the environmental impact of the system. However, with the mechanisms of the illustrative embodiments, through the marketplace, carbon credits may be exchanged and thus, a portion of the carbon credits not being used by file 3 in Rack3 may be reassigned to file 1 in Rack1 and continued access from the server in Rack1 may be performed.

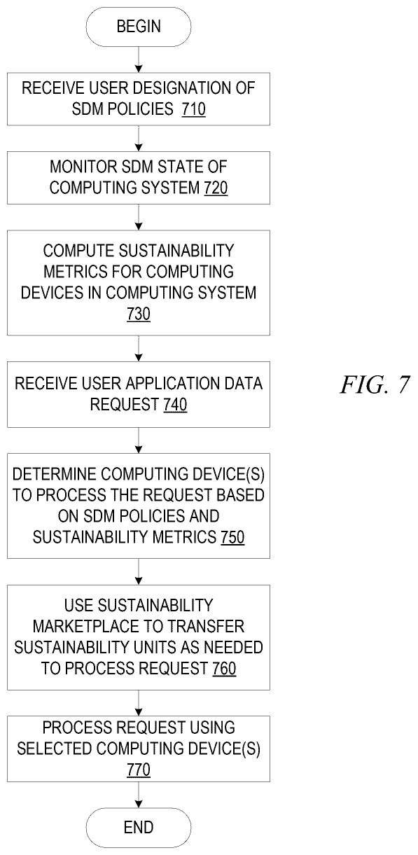

FIG. 7 presents a flowchart outlining example operations of elements of the present invention with regard to one or more illustrative embodiments. It should be appreciated that the operations outlined in FIG. 7 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 7, and may, in some cases, make use of the results generated as a consequence of the operations set forth in FIG. 7, the operations in FIG. 7 themselves are specifically performed by the improved computing tool in an automated manner.

As shown in FIG. 7, the operation starts by receiving a user designation of SDM policies to be applied to data associated with one or more user applications (step 710). The state of computing devices in a computing system is monitored on a continuous basis to obtain SDM data (step 720). The SDM data from the computing devices is used to compute sustainability metrics for the computing devices, groups of computing devices, and/or the computing system (step 730). A request to store and/or access data is received from the user application (step 740). The sustainability metrics of the computing devices, groups of computing devices, and/or the computing system are used in combination with the SDM policies for the data associated with the user application to determine which computing devices or group of computing devices to use to handle the request, e.g., storing data to, or accessing data from, the selected computing device(s) (step 750). In some illustrative embodiments, determinations are made through a sustainability marketplace as to whether sustainability metrics assigned to copies of the targeted data need to be transferred to facilitate the handling of the request and such transfers are implemented as needed (step 760). The request is then processed using the selected computing device(s) (step 770). The operation then terminates.

Thus, with the improved computing tool and improved computing tool operations/functionality of the illustrative embodiments, a SDM controller is provided that enhances the capabilities of existing data management controllers by providing an improved capability to track each file/object or group of files/objects, such as on a bucket basis, to ensure sustainability limits are not violated and sustainability goals are achieved. The SDM controller collects dynamic heatmap data for individual computing devices, groups of computing devices, and/or the computing system as a whole, and utilizes sustainability metrics for these computing devices/computing system to measure adherence to these limits and goals. The sustainability metrics may be collected and/or calculated for individual files/objects being placed in the storage of the individual computing devices and/or already being maintained in the storage of the individual computing devices. One or more data placement policies may be implemented in the SDM controller so as to place and move data, e.g., files/objects, within the computing system so as to meet the requirements of sustainability limits and goals. Moreover, one or more policies may be provided to control application accesses to copies of data (files/objects) in a manner that minimizes sustainability metric usage.

In some illustrative embodiments, the SDM controller facilitates a sustainability metric marketplace for loaning sustainability metrics between files/objects, groups of files/objects, computing devices, and groups of computing devices. This allows for balancing sustainability metric usage across files/objects in cases where some files/objects are more frequently accessed than others. That is, the sustainability metric marketplace permits the transfer of sustainability credits such that groups of files/objects can assist one another to not go beyond the overall sustainability limits defined by application users and also implemented by organizations.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a designation of a sustainability data management (SDM) policy to be applied to data associated with a user application, wherein the SDM policy specifies a sustainability limit for processing data associated with the user application;
receiving, from one or more SDM data collection agents deployed to a computing system, SDM data collected by the SDM data collection agents from sensors associated with a plurality of computing devices of the computing system;
computing at least one sustainability metric for the plurality of computing devices of the computing system based on the SDM data;
receiving a request, from the user application, targeting user application data;
selecting, based on the at least one sustainability metric and the sustainability limit of the SDM policy, at least one computing device, of the plurality of computing devices, with which to process the request; and
processing the request using the selected at least one computing device of the computing system.

2. The method of claim 1, wherein the request is a request to store the user application data to the computing system.

3. The method of claim 1, wherein the request is a request to access the user application data from the computing system.

4. The method of claim 1, wherein the sustainability limit is a maximum carbon credit usage, and wherein the sustainability metric is an amount of carbon credit usage that would occur if using a specified computing device, or group of computing devices, to process a request.

5. The method of claim 1, wherein selecting at least one computing device further comprises performing a sustainability unit transfers between computing devices of the plurality of computing devices to provide the selected at least one computing device enough sustainability units to process the request.

6. The method of claim 1, wherein computing at least one sustainability metric for the plurality of computing devices of the computing system based on the SDM data comprise computing, for each data object or file of each computing system, a corresponding sustainability metric, and wherein a sustainability metric for a computing device comprises a sum of the sustainability metrics for the data objects and files stored on the computing device.

7. The method of claim 6, further comprising:
moving data objects and files between computing devices in the plurality of computing devices based on the sustainability metrics of the data objects or files of the computing devices and the SDM policy.

8. The method of claim 1, wherein the SDM policy minimizes usage of the at least one sustainability metric across the plurality of computing devices.

9. The method of claim 1, wherein computing the at least one sustainability metric for the plurality of computing devices of the computing system based on the SDM data further comprises generating one or more heatmaps of the at least one sustainability metric, and wherein selecting the at least one computing device is performed based on the one or more heatmaps.

10. The method of claim 9, wherein the one or more sustainability metrics comprise at least one of a carbon dioxide equivalent metric, an amount of water required to cool down a corresponding computing device, or a measure of wear and tear on hardware of the corresponding computing device.

11. A computer program product comprising:
one or more computer-readable storage media; and
program instructions stored on the one or more computer-readable storage media to perform operations comprising:
receiving a designation of a sustainability data management (SDM) policy to be applied to data associated with a user application, wherein the SDM policy specifies a sustainability limit for processing data associated with the user application;
receiving, from one or more SDM data collection agents deployed to a computing system, SDM data collected by the SDM data collection agents from sensors associated with a plurality of computing devices of the computing system;
computing at least one sustainability metric for the plurality of computing devices of the computing system based on the SDM data;
receiving a request, from the user application, targeting user application data;
selecting, based on the at least one sustainability metric and the sustainability limit of the SDM policy, at least one computing device, of the plurality of computing devices, with which to process the request; and
processing the request using the selected at least one computing device of the computing system.

12. The computer program product of claim 11, wherein the request is a request to store the user application data to the computing system.

13. The computer program product of claim 11, wherein the request is a request to access the user application data from the computing system.

14. The computer program product of claim 11, wherein the sustainability limit is a maximum carbon credit usage, and wherein the sustainability metric is an amount of carbon credit usage that would occur if using a specified computing device, or group of computing devices, to process a request.

15. The computer program product of claim 11, wherein selecting at least one computing device further comprises performing a sustainability unit transfers between computing devices of the plurality of computing devices to provide the selected at least one computing device enough sustainability units to process the request.

16. The computer program product of claim 11, wherein computing at least one sustainability metric for the plurality of computing devices of the computing system based on the SDM data comprise computing, for each data object or file of each computing system, a corresponding sustainability metric, and wherein a sustainability metric for a computing device comprises a sum of the sustainability metrics for the data objects and files stored on the computing device.

17. The computer program product of claim 16, wherein the operations further comprise:
moving data objects and files between computing devices in the plurality of computing devices based on the sustainability metrics of the data objects or files of the computing devices and the SDM policy.

18. The computer program product of claim 11, wherein the SDM policy minimizes usage of the at least one sustainability metric across the plurality of computing devices.

19. The computer program product of claim 11, wherein computing the at least one sustainability metric for the plurality of computing devices of the computing system based on the SDM data further comprises generating one or more heatmaps of the at least one sustainability metric, and wherein selecting the at least one computing device is performed based on the one or more heatmaps.

20. A computer system comprising:
a processor set;
one or more computer-readable storage media; and
program instructions stored on the one or more computer-readable storage media to cause the processor set to perform operations comprising:
receiving a designation of a sustainability data management (SDM) policy to be applied to data associated with a user application, wherein the SDM policy specifies a sustainability limit for processing data associated with the user application;
receiving, from one or more SDM data collection agents deployed to a computing system, SDM data collected by the SDM data collection agents from sensors associated with a plurality of computing devices of the computing system;
computing at least one sustainability metric for the plurality of computing devices of the computing system based on the SDM data;
receiving a request, from the user application, targeting user application data;
selecting, based on the at least one sustainability metric and the sustainability limit of the SDM policy, at least one computing device, of the plurality of computing devices, with which to process the request; and
processing the request using the selected at least one computing device of the computing system.
